(19) United States
(12) Patent Application Publication
(10) Pub. No.: US 2006/0054599 A1
(43) Pub. Date: Mar. 16, 2006

(54) Graphite cloth filament welder

(76) Inventor: Erik Henry Tweeton, Granby, CO (US)

Correspondence Address: Erik Henry Tweeton, PO Box 1663, Granby, CO, 80446-1663, US

(21) Appl. No.: 11/022,160

(22) Filed: Dec. 27, 2004

Related U.S. Application Data
(60) Provisional application No. 60/608,553, filed on Sep. 10, 2004.

(51) Int. Cl. H05B 1/00

(52) U.S. Cl. 219/50

(57) ABSTRACT

A 3 mm (0.13″) diameter by 40 mm (1.6″) long graphite cloth filament is clamped between two heat shielded clamps and 12-volt 10-300 amp current travels through the invention when the switch is turned on, which heats the filament by electrical resistance. The heated cloth is placed on the weld joint to melt the metal. The welding tool allows welding 0.25 mm (0.01″) to 5 mm (0.19″) thick metals. It can also weld stainless steel without inert shielding gas from the sacrificial oxidation of the graphite cloth rope surrounding the melted metal.

### BACKGROUND OF THE INVENTION

1. Field of Invention

Welding devices is the field of this invention. This invention was made to make welding more safe and cheap. It requires knowledge of refractory ceramics and thermal properties of metals, ceramics and plastics to be successful as a household use welder.

2. Description of Related Art

This welding device uses graphite as a filament to create heat. Thomas Edison tried graphite as a light bulb filament as an alternative to tungsten. Prior welding devices for home-use have required electrical arcs or an oxygen and fuel gas torch to create the heat to weld.

### BREIF SUMMARY OF THE INVENTION

This welding product uses graphite cloth or exfoliated flake flexible graphite sheets as a filament. The filament heats up to 3500 degrees Celsius (6400 degrees Fahrenheit) by drawing 8 to 12 volts and 10 to 300 amps of electricity. These filaments are placed on the area to be welded and are brushed over the surface of the weld joint The tool that holds onto the filaments has refractory ceramic heat shielding over the copper clamps to keep the tool from overheating. Unlike arc welders, this tool does not require an electrical circuit through the metal that is being welded, which allows welding rusty metals and soft ceramics.

### BREIF DESCRIPTION OF SEVERAL VEIWS OF THE DRAWING

FIG. 1. shows the perspective view of the welder

FIG. 2. shows the close up of the filament and its clamps.

FIG. 3. shows the exploded view of all the components.

### DETAILED DESCRIPTION OF THE INVENTION

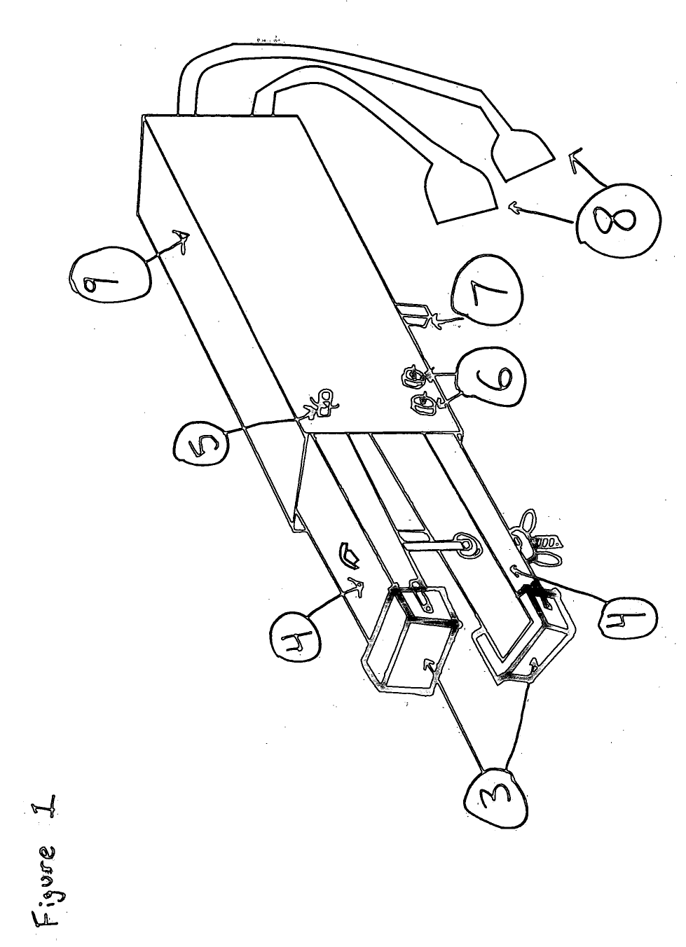

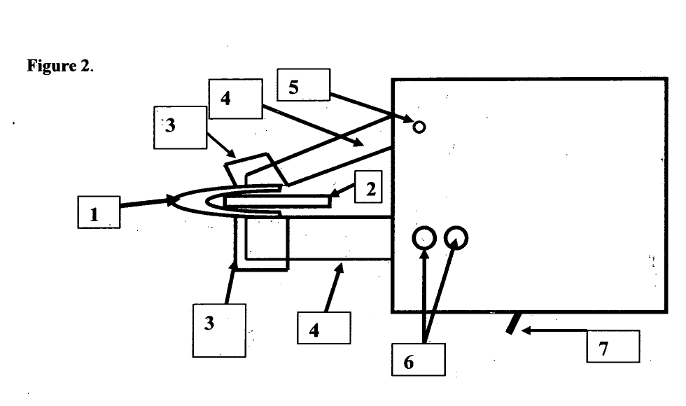

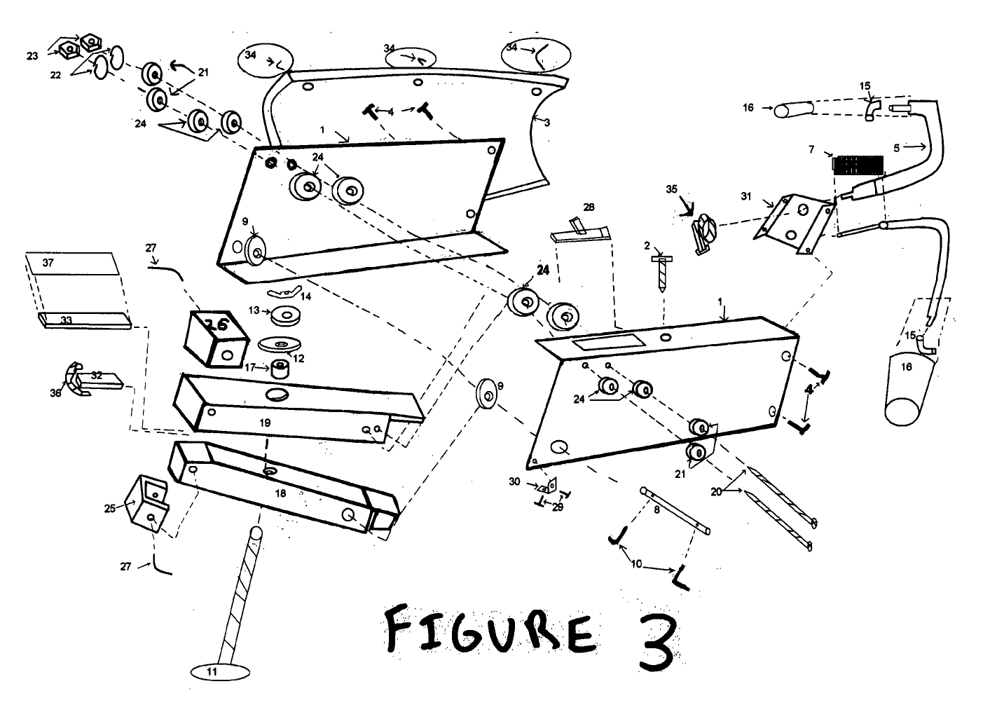

The numerals identifying the parts are described below for FIGS. 1 and 2. FIG. 3 is described on page 7.

1. The graphite cloth filament can either be clamped in between the ceramic plate and each of the copper clamps or clamped directly in between the copper clamps. Clamping the cloth with the ceramic plate in between allows an electrical circuit to flow from the moving clamp to the stationary clamp. Clamping without the ceramic plate allows the user to have a circuit through the metal that is being welded. It will oxidize in about 40 seconds which allows welding about 1 cm (0.4 inch) at a time. The maximum size cloth that can be clamped is 6.4 mm (¼-inch) diameter.

2. The self-sintered pure silicon carbide ceramic plates can accept the heat without completely melting and can electrically insulate the graphite cloth to allow a circuit through the handle frame as described in numeral 1. They are 3.2 mm (⅛ inch) thick which allows the outer surface to be melted while the inside surface is frozen.

3. The front ceramic heat shield protects the copper clamps from the heat of the graphite cloth. It is made out of 90% silicon carbide and 10% silica (by weight). It is shaped as a wet clay, then fired at 1700 degrees Celsius (3100 degrees Fahrenheit).

4. The copper clamps are 13 centimeters (0.5 inch) wide and 7.6 centimeters (3 inches) long. They clamp the filament in place and hold it securely by tightening a wing nut connected to a thumbscrew.

5. The porcelain axle holds the moving clamp to the handle frame. It is made from porcelain that is fired at 1300 degrees Celsius (2400 degrees Fahrenheit).

6. Silicone washers insulate the stationary clamp from heat and electricity so it doesn't overheat or short-circuit the handle frame. The silicone can handle 260 degrees C. (500 degrees F.) without melting.

7. The on/off switch stays on or off. It carries 300 amps or less and is about 3 centimeters or 1 inch long.

8. The electrical cables can carry up to 300 amps and are about 4 millimeters or 0.15 inches in diameter. They are 0.1 meters long (4 inches).

9. The handle frame is made out of stainless steel to allow the front end near the clamps to to be 260 degrees Celsius (500 degrees F.) while the end of it where the operators hand is located, gets only 66° C. (150° F.). It is 0.762 millimeters (0.03 inches) thick and 6 inches long.

### DETAILED DESCRIPTION OF THE INVENTION

This description is for FIG. 3 which identifies each of the parts. The numbers for the descriptions match the parts for FIG. 3 only.

1 is the stainless steel handle frame. 2 is the nylon bolt and nut to hold #28 in place. 3 is the silicone handle cover. 4 are sheet metal screws that connect #31 to #1. 5 is the cable for the stationary clamp described in FIG. 1 #8. 6 is the cable for the moving clamp. 7 is a sheet of fiberglass cloth which is wrapped around #6 to electrically insulate it from #1

8 is the porcelain axle described in FIG. 1 #5. 9 are porcelain axle washers that go over #8, and electrically and thermally insulate #18 from #1. 10 are cotter pins to hold #8 in place on #1. 11 is the bolt that allows #18 and #19 to be pressed together when #14 is turned. 12 is the ceramic washer that electrically insulates #11 from #19. 13 is a steel washer that prevents #14 from being scratched by #12 when it is rotated.

14 is a wing nut that screws onto #11 to compress the two copper clamps, #18 and #19.15 are hollow copper elbows that are clamped by the 12-volt power source cables (not included). 16 are rubber tubes to protect #15 from creating a short circuit if accidentally touched together. 17 is a porcelain collar to go around #11 to electrically insulate it from #19. 18 is the moving copper clamp that is described in FIG. 1 #4. 19 is the stationary clamp also described in FIG. 1 #4. 20 are the steel bolts that connect #19 to #1. 21 are the steel washers that go over #20 and prevent the lock washers #22 from puncturing the silicone washers #24. 22 are lock washers for the bolts #20 and nuts #23.

23 are nuts that screw on #20 to connect #19 to #1. 24 are the silicone washers that are described in FIG. 1 #6. 25 is the moving clamps' heat shield described in FIG. 1 #3.26 is the stationary clamps' heat shield also described in FIG. 1 #3.27 are wires that connect the heat shields #25 and #26 to #18 and #19 respectively. 28 is the on off switch that is described in FIG. 1 #7.29 are sheet metal screws to connect the front bottom corner of #1 together.

30 is a L shaped piece of sheet metal as a brace to connect the front bottom corner of #1 together. (31 was discontinued). 32 is the sintered silicon carbide plate that electrically insulates the two copper clamps which allows electricity to flow from #18 to #19 through the graphite cloth #36. 33 is the longer and more slender sintered silicon carbide plate for use to give extra strength to #37. 34 are rubber-coated wires to attach the ends of #3 together. 35 is a hose clamp that clamps on to #6 to prevent #6 from being pulled out of the crimped connection to #18.

36 is a 3 millimeter (⅛ inch) diameter by 4 centimeter (1.6 inch) long rope of graphite cloth that is described in FIG. 2 #1.37 is a 1.5 millieter (0.06 inch) thick, 6.4 millimeters (¼ inch) wide by 3.2 centimeter (1.25 inch) long plate of exfoliated flake flexible graphite.

What is claimed to be new and desired to be secured by united states patents:

1. This invention allows partial shielding from oxidation of metals when the metal is melted. This partial shielding is from the sacrificial oxidation of the graphite cloth that is surrounding the melted metal. This allows welding stainless steel, which previously have required inert shielding gas or solid chemical powders to be surrounding the melted metal to avoid oxidation.

2. This welder uses direct electrical current to heat graphite cloth by electrical resistance to temperatures suitable for welding.
